(19) United States
(12) Patent Application Publication
(10) Pub. No.: US 2025/0360866 A1
(43) Pub. Date: Nov. 27, 2025

(54) VEHICLE HEADLIGHT SYSTEM

(71) Applicant: STANLEY ELECTRIC CO., LTD., Tokyo (JP)

(72) Inventors: Wataru NAKASHIMA, Tokyo (JP); Takeshi WARAGAYA, Tokyo (JP); Kazuya WAKABAYASHI, Tokyo (JP)

(21) Appl. No.: 19/214,830

(22) Filed: May 21, 2025

(30) Foreign Application Priority Data
May 24, 2024 (JP) 2024-085035

(51) Int. Cl. B60Q 1/08; F21S 41/663

(52) U.S. Cl. CPC B60Q 1/085; F21S 41/663; B60Q 2300/312

(57) ABSTRACT

A vehicle headlight system including: a pair of headlights arranged in front of an own vehicle; a sensor configured to detect at least rainfall or wet road condition around the own vehicle; and a controller connected to the pair of headlights and the sensor and configured to control the operation of the pair of headlights, where the pair of headlights are configured to be able to irradiate low beam at least in front of the own vehicle and to change the illuminance of a partial range within an irradiation range of the low beam, and where, when formation of a water film is estimated, the controller controls the irradiation state of the pair of headlights so as to relatively increase the illuminance of the partial range.

The present application is based on, and claims priority under 35 U.S.C. 119 from Japanese Patent Application Serial Number 2024-085035 filed on May 24, 2024, the disclosure of which is hereby incorporated by reference herein in its entirety.

### BACKGROUND

### Technical Field

The present disclosure relates to a vehicle headlight system.

### Description of the Background Art

Japanese Patent No. 7177802 (Patent Document 1) describes a vehicle lamp that emits a supplementary low beam in addition to a normal low beam to ensure brightness on the near side in front of an own vehicle (the side close to the own vehicle). The irradiation range of this supplementary low beam is set by each of the left and right lamp units so that an optimal irradiation state is obtained for a width of 5 to 15 m in front of the own vehicle and 3.5 m on both the left and right sides of the own vehicle.

Here, when water film forms on the road surface due to rainfall or other reasons, the low beam irradiated to the road surface is mirror-reflected and its component which travels to the far side increases. As a result, the brightness in front of the own vehicle becomes insufficient compared to when there is no water film and the low beam is scattered on the road surface. In contrast, it is possible to ensure brightness in front of the own vehicle by using the supplementary low beam as described above, or by increasing the light irradiated to a partial range within the irradiation range of the normal low beam by other means.

However, depending on the relative position of the own vehicle and a preceding vehicle or an oncoming vehicle (hereinafter collectively referred to as “other vehicles”), reflected light formed by the supplementary low beam, which is mirror-reflected from the road surface may cause glare to other vehicles.

In a specific aspect, it is an object of the present disclosure to provide a technology that can ensure brightness on the near side in front of the own vehicle while preventing glare to other vehicles, during rainy conditions, etc.

### SUMMARY

A vehicle headlight system according to one aspect of the present disclosure is vehicle headlight system including:

a pair of headlights arranged in front of an own vehicle;

a sensor configured to detect at least rainfall or wet road condition around the own vehicle; and

a controller connected to the pair of headlights and the sensor and configured to control the operation of the pair of headlights,

where the pair of headlights are configured to be able to irradiate low beam at least in front of the own vehicle and to change the illuminance of a partial range within an irradiation range of the low beam, and

where, when formation of water film is estimated based on the detection results of the sensor, the controller controls the irradiation state of the pair of headlights so as to relatively increase the illuminance of the partial range.

According to the above configuration, it is possible to simultaneously ensure brightness on the near side in front of the own vehicle while preventing glare to other vehicles during rainy conditions, etc.

### BRIEF DESCRIPTION OF THE DRAWINGS

FIG. 1 is a block diagram for explaining the configuration of a vehicle headlight system according to the first embodiment.

FIG. 2A to FIG. 2C are schematic diagrams illustrating configuration examples of the left side headlight and right side headlight.

FIG. 3A and FIG. 3B are diagrams for explaining capable irradiation range of the supplementary low beam according to the first embodiment.

FIG. 4A and FIG. 4B are overhead views for explaining capable irradiation range of each supplementary low beam ALB1, ALB2.

FIG. 5A and FIG. 5B are diagrams showing an example of the irradiation range of the supplementary low beam.

FIG. 6A and FIG. 6B are overhead views for explaining capable irradiation range of each supplementary low beam ALB1, ALB2.

FIG. 7A is a diagram for explaining a method for setting the right side boundary of the capable irradiation range of supplementary low beam ALB1.

FIG. 7B is a diagram for explaining a method for setting the left side boundary of the capable irradiation range of supplementary low beam ALB1.

FIG. 7C is a diagram showing the left side boundary and the right side boundary of the capable irradiation range of supplementary low beam ALB1.

FIG. 8A is a diagram for explaining a method for setting the upper side boundary of the capable irradiation range of supplementary low beam ALB1.

FIG. 8B is a diagram showing the left side boundary, the right side boundary, and the upper side boundary of the capable irradiation range of supplementary low beam ALB1.

FIG. 9 is a flowchart showing the operating procedure of the vehicle headlight system 1 according to the first embodiment.

FIG. 10 is a schematic diagram for explaining a situation in which the own vehicle is traveling on a left curve road and an oncoming vehicle is present.

FIG. 11 is a block diagram showing the configuration of a vehicle headlight system according to the second embodiment.

FIG. 12 is a flowchart showing the operating procedure of vehicle headlight system 1A according to the second embodiment.

FIG. 13 is a flowchart showing another aspect of the operating procedure of the vehicle headlight system 1A according to the second embodiment.

FIG. 14 is a block diagram showing the configuration of a vehicle headlight system according to the third embodiment.

FIG. 15A is an overhead view showing the relative positional relationship between the own vehicle and an oncoming vehicle.

FIG. 15B and FIG. 15C are side views showing the relative positional relationship between the own vehicle and an oncoming vehicle.

FIG. 16A is a diagram showing the definition of a left-right direction angle θ1.

FIG. 16B is a diagram showing the definition of the up-down direction angle θ2.

FIG. 17 is a diagram for explaining the corresponding relationship on the screen between left-right direction angle θ1 and up-down direction angle θ2.

FIG. 18A is a diagram showing the transition of eye position on a screen.

FIG. 18B is a diagram illustrating irradiation range of a supplementary low beam including a light shielding range.

FIG. 19A is a diagram showing the definition of the left-right direction angle θ3.

FIG. 19 B is a diagram showing the definition of the up-down direction angle θ4.

FIG. 20 is a flowchart showing the operation procedure of a vehicle headlight system 1B according to the third embodiment.

### DESCRIPTION OF THE PREFERRED EMBODIMENTS

### First Embodiment

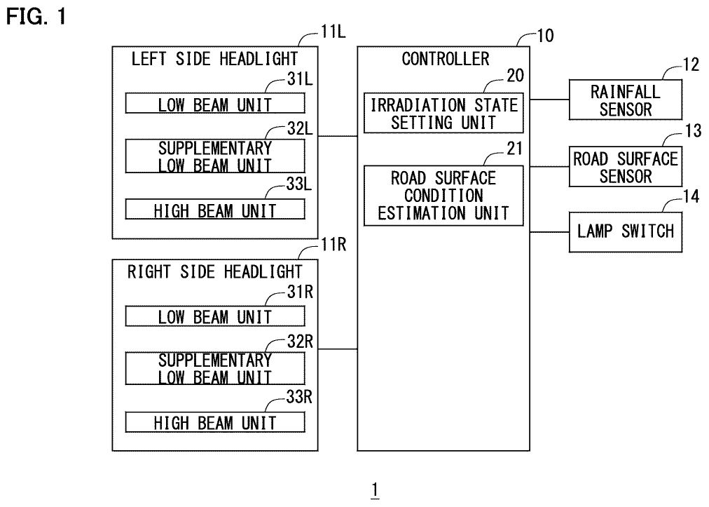

FIG. 1 is a block diagram for explaining the configuration of a vehicle headlight system according to the first embodiment. The vehicle headlight system 1 according to the first embodiment is configured to include a controller 10, a pair of headlights which are a left side headlight 11L and a right side headlight 11R, a rainfall sensor 12, and a road surface sensor 13. Controller 10 is connected to a lamp switch 14 provided in the own vehicle, and is also connected to rainfall sensor 12 and road surface sensor 13. Further, controller 10 is connected to left side headlight 11L and right side headlight 11R. Here, note that in this specification, “connected” does not necessarily mean a direct connection via wiring or a communication line, but includes an indirect connection so that an electrical signal can be obtained via another control device, etc (not shown). Further, in the first embodiment, the rainfall sensor 12 and/or the road surface sensor 13 correspond to “sensor(s)”.

Controller 10 controls the overall operation of vehicle headlight system 1, and is realized, for example, by executing a predetermined operating program on a computer having a processor and a memory. This controller 10 has, as functional blocks, an irradiation state setting unit (irradiation state setting function) 20 and a road surface condition estimation unit (road surface condition estimation function) 21.

Based on the operation state of lamp switch 14 and estimation result from road surface condition estimation unit 21, irradiation state setting unit 20 sets light irradiation state of each of left side headlight 11L and right side headlight 11R, and supplies a control signal according to the settings to each of left side headlight 11L and right side headlight 11R.

Road surface condition estimation unit 21 estimates the condition of the road surface of the own vehicle's traffic lane based on the detection results of rainfall sensor 12 and road surface sensor 13. Specifically, road surface condition estimation unit 21 estimates that a water film has formed on the road surface when there is rainfall (when amount of rainfall is equal to or greater than a predetermined reference value) or when the road surface is in a wet state. The presence or absence of rainfall and the amount of rainfall are determined based on the detection results of rainfall sensor 12. The presence or absence of wet state of the road surface is determined based on the detection results of road surface sensor 13.

Left side headlight 11L and right side headlight 11R are each installed in front of the own vehicle and are configured to be able to irradiate light ahead of the vehicle. Left side headlight 11L is installed on the left front side of an own vehicle 100, and right side headlight 11R is installed on the right front side of the own vehicle. Left side headlight 11L has a low beam unit 31L, a supplementary low beam unit 32L, and a high beam unit 33L. Right side headlight 11R has a low beam unit 31R, a supplementary low beam unit 32R, and a high beam unit 33R.

Low beam units 31L, 31R are units configured to be able to emit low beam (passing light) in front of the own vehicle. In the following description, the combined light irradiated from low beam units 31L, 31R may be referred to as low beam, and the light emitted from either low beam unit 31L, 31R may also be referred to as low beam.

Supplementary low beam units 32L, 32R are units configured to be able to emit a supplementary low beam in front of the own vehicle. The supplementary low beam here refers to a light that is emitted to a partial range within the irradiation range of the low beam described above in order to relatively increase the illuminance of the partial range. Here, note that “to relatively increase the illuminance” means that the illuminance of the partial range is increased compared to when low beam is emitted without emitting the supplementary low beam.

High beam units 33L, 33R are units configured to be able to emit high beam (driving light) ahead of the own vehicle. In the following description, the combined light of light emitted from high beam units 33L, 33R may be referred to as high beam, and the light emitted from either high beam unit 33L, 33R may also be referred to as high beam. High beam units 33L, 33R may be units capable of emitting selective high beam with a dimming range set according to the position of an oncoming vehicle or a preceding vehicle, etc.

Rainfall sensor 12 is a sensor that detects the presence or absence of rainfall and the amount of rainfall in the vicinity of the own vehicle. Rainfall sensor 12 can be an optical sensor that detects raindrops by emitting light such as infrared light onto the windshield and detecting the reflected light, for example.

Here, rainfall sensor 12 may be a sensor that detects the presence or absence of rainfall based on images of the area around the own vehicle captured by a camera (not shown). Further, rainfall sensor 12 may also be a sensor that obtains weather information from outside via wireless communication.

Road surface sensor 13 is a sensor that detects the road surface condition of the traffic lane on which the own vehicle is traveling, specifically, detects whether the road surface is wet or not. Road surface sensor 13 can be an optical sensor that detects the road surface condition by emitting light such as laser light toward the road surface and detecting the reflected light, for example.

Here, road surface sensor 13 may be a sensor that detects road surface condition based on an image of the road surface captured by a camera (not shown). Further, road surface sensor 13 may also be a sensor that detects road surface condition detecting in the by acceleration circumferential direction (rotational direction) of the tire using an acceleration sensor attached to the inner surface of the tire of the own vehicle.

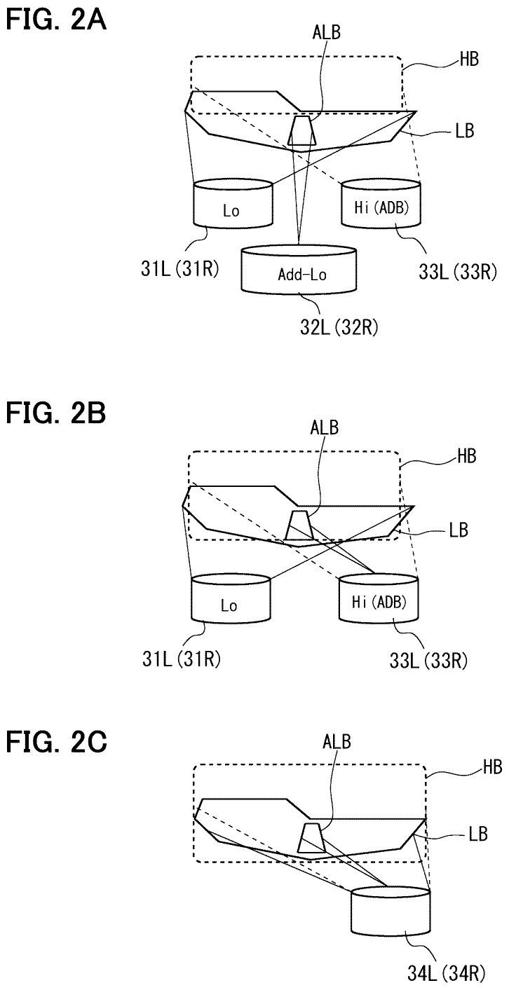

FIG. 2A to FIG. 2C are schematic diagrams illustrating configuration examples of the left side headlight and right side headlight. Here, note that each figure shows configuration example of left side headlight 11L, but right side headlight 11R has a similar configuration. The configuration example shown in FIG. 2A corresponds to left side headlight 11L shown in FIG. 1, and the configuration examples shown in FIG. 2B and FIG. 2C are modified execution examples that can achieve the same function.

FIG. 2A shows a schematic configuration of left side headlight 11L in vehicle headlight system 1 shown in FIG. 1. Specifically, low beam unit 31L irradiates a low beam LB ahead of the own vehicle, and high beam unit 33L irradiates a high beam HB ahead of the own vehicle. High beam HB may be a selective high beam (ADB). Further, supplementary low beam unit 32L irradiates a supplementary low beam ALB within the irradiation range of low beam LB. In this configuration example, low beam units 31L and 31R correspond to a “first unit” and supplementary low beam units 32L and 32R correspond to a “second unit”.

The configuration example shown in FIG. 2B is an example in which the function of supplementary low beam unit 32L is replaced by high beam unit 33L. In this configuration example, compared to the configuration example shown in FIG. 2A, the irradiation range of high beam HB emitted by high beam unit 33L is expanded so that its bottom end position is closer to the bottom end position of low beam LB. And supplementary low beam ALB is formed by relatively increasing illuminance of a partial range of high beam HB within this expanded irradiation range. In this configuration example, low beam units 31L, 31R correspond to the “first unit” and high beam units 33L, 33R correspond to the “second unit”.

The configuration example shown in FIG. 2C is an example in which the functions of low beam unit 31L, high beam unit 32L, and supplementary low beam unit 32L are integrated into a high-definition light source unit 34L. In this configuration example, compared to the configuration example shown in FIG. 2A,

the irradiation range of high beam HB emitted by high-definition light source unit 34L is expanded so that its bottom end position is closer to the bottom end position of low beam LB. And supplementary low beam ALB is formed by relatively increasing the illuminance of a partial range of the expanded irradiation range of high beam HB. Further, low beam LB is formed by high-definition light source unit 34L. In this configuration example, high-definition light source units 34L and 34R correspond to a “third unit”.

In each of the above configuration examples, high beam unit 32L (32R) capable of emitting a selective high beam and high-definition light source unit 34L (34R) can each be configured using a light source capable of emitting laser light and an optical deflector such as a MEMS mirror that scans the laser light, for example. Alternatively, high beam unit 32L etc. can be configured using a light source (LED, laser, etc.) and a liquid crystal element that can partially control the transmittance of light emitted from the light source. Further, high beam unit 32L etc. can also be configured using a light source in which a large number of extremely small LEDs are densely mounted and a lens optical system that projects light emitted from the light source.

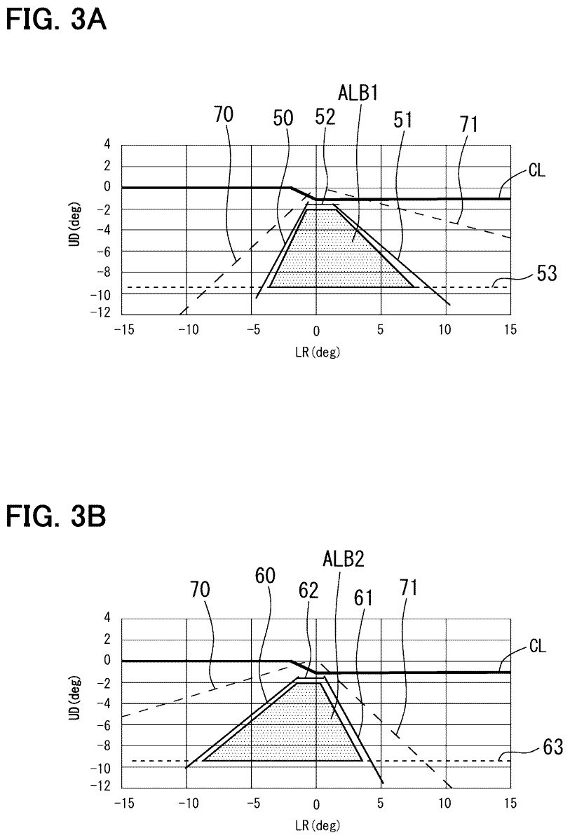

FIG. 3A and FIG. 3B are diagrams for explaining capable irradiation range of the supplementary low beam according to the first embodiment. In each figure, the capable irradiation range of the supplementary low beam is shown with a pattern on a screen assumed to be arranged vertically at a predetermined position in front of the own vehicle (e.g. 25 m in front of the own vehicle). In detail, FIG. 3A shows the capable irradiation range of an supplementary low beam ALB1 from supplementary low beam unit 32L of left side headlight 11L, and FIG. 3B shows the capable irradiation range of an supplementary low beam ALB2 from supplementary low beam unit 32R of right side headlight 11R. In each figure, a cutoff line CL corresponds to the upper end position of the low beam. In this specification, it is assumed that the own vehicle is legally required to drive on the left side of the road. That is, in this specification, the oncoming vehicle corresponds to a “first forward vehicle” and the preceding vehicle corresponds to a “second forward vehicle”.

In the first embodiment, each of supplementary low beams ALB1, ALB2 is irradiated when rainfall is detected and/or a wet state of the road surface is detected, and thus it is estimated that a water film has formed on the road surface. At this time, each supplementary low beam ALB1, ALB2 has a capable irradiation range set so as not to cause glare to the driver of an oncoming vehicle or a preceding vehicles due to mirror-reflected (regularly reflected) light from the road surface.

Based on the installation positions of supplementary low beam units 32L, 32R, the position of the driver's eyes of the oncoming vehicle assumed to be present (first position) and the position of the mirror (rear mirror or side mirror) of the preceding vehicle assumed to be present (second position) are set, respectively, and a boundary between the positions in which the mirror-reflected light from the road surface enters each position and the positions where it does not enter is calculated, and the capable irradiation range is set based on this boundary.

Specifically, as shown in FIG. 3A, the capable irradiation range of supplementary low beam ALB1 is defined by a left side boundary 50, a right side boundary 51, an upper side boundary 52 and a lower side boundary 53. Similarly, as shown in FIG. 3B, capable the irradiation range of supplementary low beam ALB2 is defined by a left side boundary 60, a right side boundary 61, an upper side boundary 62 and a lower side boundary 63.

Left side boundaries 50, 60 each define the left end of capable irradiation range, and are the boundaries between positions where reflected light is incident on a preceding vehicle, which is assumed to be relatively to the left side of the own vehicle, and a position where it is not incident thereon. Right side boundaries 51, 61 each define the right end of capable irradiation range, and are the boundaries between positions where reflected light is incident on an oncoming vehicle, which is assumed to be relatively to the right side of the own vehicle, and a position where it is not incident thereon.

It is preferable that each of left side boundaries 50, 60 and right side boundaries 51, 61 be set based on numerical conditions that do not cause glare to the driver of a preceding vehicle or an oncoming vehicle, even when the preceding vehicle or the oncoming vehicle is not a regular vehicle but a large vehicle such as a truck. Further, it is preferable that each of left side boundaries 50, 60 and right side boundaries 51, 61 be set so that the light emitted passes above the preceding vehicle or the oncoming vehicle. This is to prevent the formation of new glare caused by the light hitting the body of an oncoming vehicle, etc. Details of how left side boundaries 50, 60 and right side boundaries 51, 61 are set will be described later.

Upper side boundaries 52, 62 each define the upper end of the capable irradiation range and are preferably set below the upper end of the low beam (i.e. the cutoff line CL). This is because supplementary low beams ALB1, ALB2 are intended to irradiate the road surface. Lower side boundaries 53, 63 each define the lower end of the capable irradiation range and are preferably set at a position visible to the driver of the own vehicle, for example, 5 m ahead of the own vehicle.

The distance between upper side boundary 52 and lower side boundary 53, and the distance between upper side boundary 62 and lower side boundary 63 can be set so as to be able to irradiate an area between 5 m and 35 m ahead of the own vehicle, for example. Specifically, for example, when height of the installation position of supplementary low beam units 32L and 32R is 0.9 m, the range can be set from −1.5 degrees to −10.0 degrees (1.5 D to 10.0 D). Further, for example, when height of the installation position of supplementary low beam units 32L and 32R is 0.6 m, the range can be set from −1.0 degrees to −6.8 degrees (1.0 D to 6.8 D). In other words, the area or the range can be set according to the type and specifications of the own vehicle. Taking the preceding vehicle into consideration, it is preferable that lower side boundaries 53 and 63 are set at −4.0 degrees (4.0 D).

The shape of the capable irradiation range on the screen will now be described in more detail. As shown in FIG. 3A, left side boundary 50 and right side boundary 51 have different inclination angles with respect to the vertical direction. Similarly, as shown in FIG. 3B, left side boundary 60 and right side boundary 61 have different inclination angles with respect to the vertical direction. In detail, compared to a case where irradiation is formed over the entire traffic lane width of the traffic lane of the own vehicle, which is specified between a traffic lane left edge 70 and a traffic lane right edge 71 of the traffic lane, the angle between left side boundary 50, 60 and the horizontal direction (left and right direction in the figure) is greater than the angle between traffic lane left edge 70 and the horizontal direction. Similarly, the angle between right side boundary 51, 61 and the horizontal direction (left and right direction in the figure) is greater than the angle between traffic lane left edge 71 and the horizontal direction. Further, the length of each of upper side boundaries 52, 62 and lower side boundaries 53, 63 is shorter than the traffic lane width (i.e., the length between the traffic lane left edge 70 and the traffic lane right edge 71 of the traffic lane).

By irradiating each of supplementary low beams ALB1, ALB2 within the capable irradiation range thus set, glare due to mirror-reflected light from the road surface caused by each of supplementary low beams ALB1, ALB2 can be avoided to the driver of an oncoming vehicle, etc. Here, the shapes of each of supplementary low beams ALB1, ALB2 on the screen may be asymmetric. Further, the luminous intensities of each of supplementary low beams ALB1, ALB2 may be different.

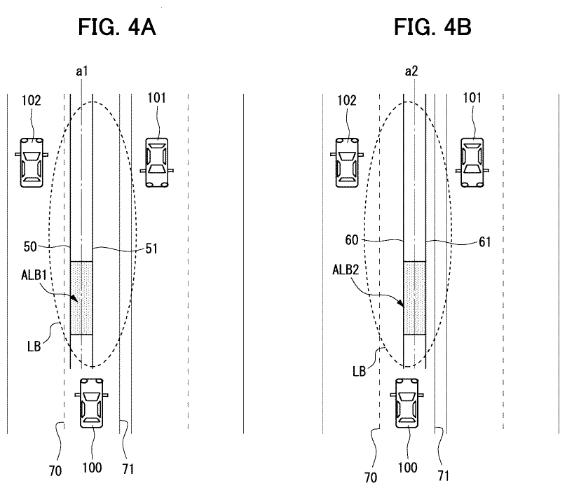

FIG. 4A and FIG. 4B are overhead views for explaining capable irradiation range of each supplementary low beam ALB1, ALB2. In each figure, a schematic plane view of own vehicle 100, an oncoming vehicle 101, and a preceding vehicle 102 is shown. As shown in each figure, it is assumed that own vehicle 100 is traveling within a traffic lane defined by traffic lane left edge 70 and traffic lane right edge 71, and that oncoming vehicle 101 is present on the oncoming traffic lane to the right side of own vehicle 100's traffic lane, and preceding vehicle 102 is present on the traffic lane to the left side of own vehicle 100's traffic lane.

Supplementary low beam ALB1 emitted from left side headlight 11L of own vehicle 100 is included within the irradiation range of low beam LB. Supplementary low beam ALB1 is emitted in the direction of an optical axis a1 of supplementary low beam unit 32L. In the illustrated example, left side boundary 50 and right side boundary 51 of the capable irradiation range of supplementary low beam ALB1 are approximately parallel to optical axis a1 and are set within traffic lane left edge 70 and traffic lane right edge 71. The position of left side boundary 50 is set so that mirror position of preceding vehicle 102 is assumed and the light caused by road surface reflection does not enter the mirror position of preceding vehicle 102. The position of right side boundary 51 is set so that eye position of the driver of oncoming vehicle 101 is assumed and reflected light caused by road surface reflection does not enter the eye position of the driver of oncoming vehicle 101. In this example, supplementary low beam ALB1 is irradiated over a wide area such that its left and right ends approximately coincide with left side boundary 50 and right side boundary 51, respectively, of the capable irradiation range.

Further, supplementary low beam ALB2 emitted from right side headlight 11R of own vehicle 100 is included within the irradiation range of low beam LB. Supplementary low beam ALB2 is emitted in the direction of optical axis a2 of supplementary low beam unit 32R. In this example, left side boundary 60 and right side boundary 61 of the capable irradiation range of supplementary low beam ALB2 are approximately parallel to optical axis a2 and are set within traffic lane left edge 70 and traffic lane right edge 71. The position of left side boundary 60 is set so that mirror position of preceding vehicle 102 is assumed and reflected light caused by road surface reflection does not enter the mirror position of preceding vehicle 102. The position of right side boundary 61 is set so that eye position of the driver of oncoming vehicle 101 is assumed and reflected light caused by road surface reflection does not enter the eye position of the driver of oncoming vehicle 101. In this example, supplementary low beam ALB2 is irradiated over a wide area such that its left and right ends approximately coincide with left side boundary 60 and right side boundary 61, respectively, of the capable irradiation range.

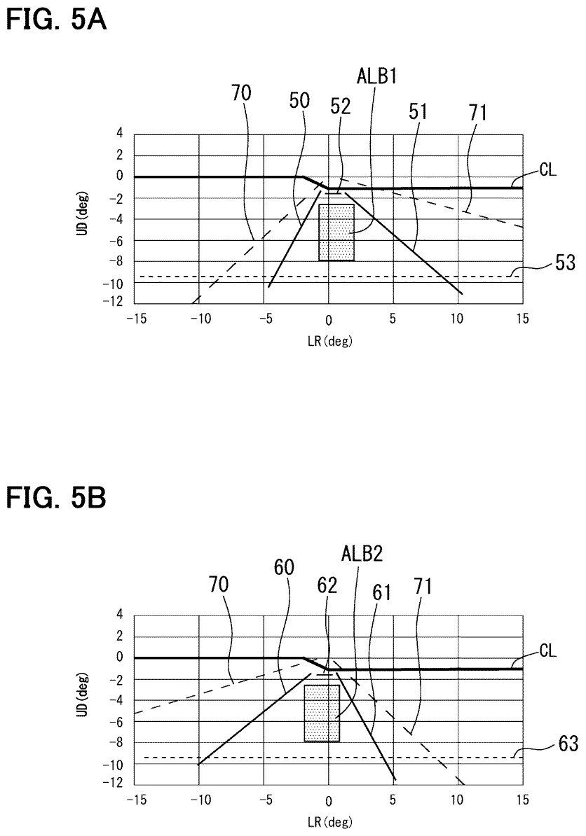

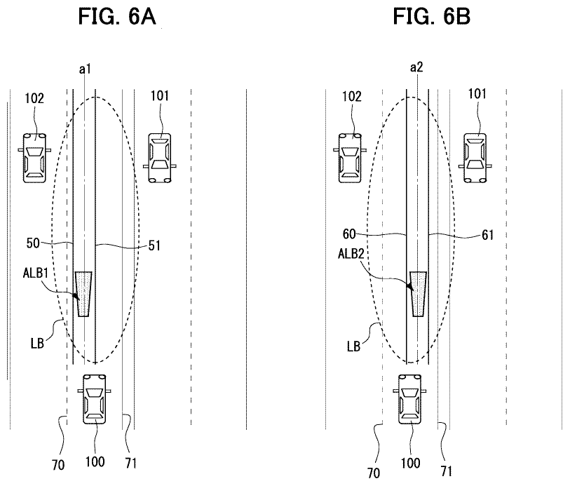

FIG. 5A and FIG. 5B are diagrams showing an example of the irradiation range of the supplementary low beam. In each figure, capable irradiation range of the supplementary low beam is shown with a pattern on a screen assumed to be arranged vertically at a predetermined position in front of the own vehicle (e.g., 25 m in front of the own vehicle). FIG. 6A and FIG. 6B are overhead views for explaining capable irradiation range of each supplementary low beam ALB1, ALB2. FIG. 5A and FIG. 6A show the capable irradiation range of supplementary low beam ALB1 from supplementary low beam unit 32L of left side headlight 11L. FIG. 5B and FIG. 6B show the capable irradiation range of supplementary low beam ALB2 from supplementary low beam unit 32R of right side headlight 11R. The symbols in the figures are the same as those described above, and detailed descriptions will be omitted.

Supplementary low beam ALB1 shown in FIG. 5A and FIG. 6A has an irradiation range set within the capable irradiation range defined by left side boundary 50, right side boundary 51, upper side boundary 52, and lower side boundary 53. Compared to supplementary low beam ALB1 shown in FIG. 3A and FIG. 4A described above, the area of the irradiation range is set relatively small, and is set closer to the center of the capable irradiation range. Further, the shape of supplementary low beam ALB1 on the screen is a rectangle with its long side approximately parallel to the vertical direction and its short side approximately parallel to the horizontal direction.

Supplementary low beam ALB2 shown in FIG. 5B and FIG. 6B has an irradiation range set within the capable irradiation range defined by left side boundary 60, right side boundary 61, upper side boundary 62, and lower side boundary 63. Compared to supplementary low beam ALB2 shown in FIG. 3B and FIG. 4B described above, the area of the irradiation range is set relatively small, and is set closer to the center of the capable irradiation range. Further, the shape of supplementary low beam ALB2 on the screen is a rectangle with its long side approximately parallel to the vertical direction and its short side approximately parallel to the horizontal direction.

Further, supplementary low beam ALB1 shown in FIG. 5A, etc. and supplementary low beam ALB2 shown in FIG. 5B, etc. have a symmetrical shape. As in this example, supplementary low beams ALB1 and ALB2, which have a small area relative to the capable irradiation range and are set closer to the center of the capable irradiation range, are suitable for use as a fixed light distribution regardless of the situation of preceding or oncoming vehicles, for example.

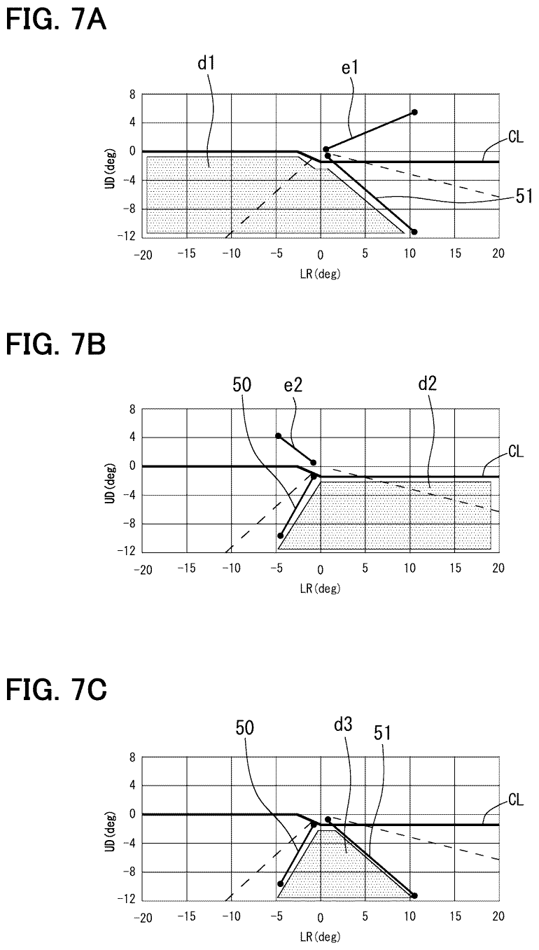

FIG. 7A is a diagram for explaining a method for setting the right side boundary of the capable irradiation range of supplementary low beam ALB1. FIG. 7B is a diagram for explaining a method for setting the left side boundary of the capable irradiation range of supplementary low beam ALB1. Here, presence of an oncoming vehicle is assumed to be on the right side of the own vehicle, and the position of its driver's eyes is estimated. Further, presence of a preceding vehicle is assumed to be on the left side of the own vehicle, and its mirror position is estimated. In the present embodiment, in order to prevent glare even in a large vehicle such as a truck, eye position of the driver of the large vehicle is assumed. The eye position of the driver of the large vehicle is 2.2 m above ground, for example.

As an example, the position of the driver's eyes when an oncoming vehicle is located anywhere between 220 m ahead and 15 m ahead in reference to the own vehicle is shown by line segment e1 in FIG. 7A. When the supplementary low beam irradiated from the position of supplementary low beam unit 32L and the reflected light is mirror-reflected from the road surface and enters the eye position shown by line segment e1, the reflection position of the reflected light at the road surface becomes right side boundary 51 of the capable irradiation range. In other words, right side boundary 51 is determined based on the line segment as a collection of reflection positions (road surface coordinates) at the road surface between 220 m ahead and 15 m ahead. When only an oncoming vehicle is considered, a range d1 (shown with a pattern) to the left of right side boundary 51 and below cutoff line CL becomes the capable irradiation range.

Similarly, as an example, the mirror position when a preceding vehicle is located anywhere between 220 m ahead and 15 m ahead in reference to the own vehicle is shown by line segment e2 in FIG. 7B. When supplementary low beam is irradiated from the position of supplementary low beam unit 32L and the reflected light is mirror-reflected from the road surface and enters the eye position shown by line segment e2, the reflected position of the reflected light at the road surface becomes left side boundary 50 of the capable irradiation range. In other words, left side boundary 50 is determined based on the line segment as a collection of the reflection positions (road surface coordinates) at the road surface between 220 m ahead and 15 m ahead. When only a preceding vehicle is considered, a range d2 (shown with a pattern) to the right of left side boundary 50 and below the cutoff line CL becomes the capable irradiation range.

The specific positions of left side boundary 50 and right side boundary 51 can be calculated by setting conditions such as the installation position (height above ground) of supplementary low beam unit 32L, the vehicle width, and the traffic lane width, etc. based on general numerical values. A detailed calculation example will be described in detail in the third embodiment described later. Here, although explanation is omitted, note that left side boundary 60 and right side boundary 61 of supplementary low beam ALB2 from supplementary low beam unit 32R can be obtained in a similar manner.

FIG. 7C is a diagram showing the left side boundary and the right side boundary of the capable irradiation range of supplementary low beam ALB1. A range d3 is defined by left side boundary 50, right side boundary 51, and cutoff line CL, that is, the overlapping range of the above ranges d1 and d2. When a preceding vehicle on the traffic lane of the own vehicle is not taken into account, this range d3 can be used as the capable irradiation range.

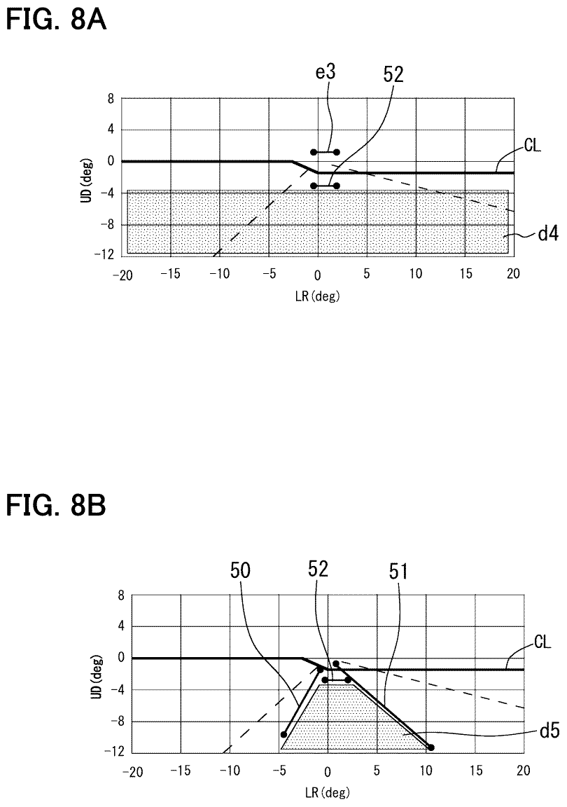

FIG. 8A is a diagram for explaining a method for setting the upper side boundary of the capable irradiation range of supplementary low beam ALB1. Here, presence of a preceding vehicle is assumed on the traffic lane of the own vehicle, and the mirror position of the preceding vehicle is estimated. In the present embodiment, in order to prevent glare even in a large vehicle such as a truck, the mirror position of a large vehicle is assumed. The mirror position of the large vehicle is 2.2 m above ground, for example.

As an example, the position of the mirror when the preceding vehicle is 220 m straight ahead is shown by line segment e3 in FIG. 8A. When the supplementary low beam irradiated from the position of supplementary low beam unit 32L and the reflected light is mirror-reflected from the road surface and enters the mirror position shown by the line segment e3, the reflection position of the reflected light at the road surface becomes upper side boundary 52 of the capable irradiation range. When only a preceding vehicle on the own vehicle's traffic lane is considered, a range d4 (shown with a pattern) on the lower side of upper side boundary 52 and below the cutoff line CL becomes the capable irradiation range.

The specific position of upper side boundary 52 can be calculated by setting conditions such as the installation position (height above ground) of supplementary low beam unit 32L, the vehicle width, and traffic lane width, etc. based on general numerical values. Here, although explanation is omitted, note that upper side boundary 62 of supplementary low beam ALB2 from supplementary low beam unit 32R can be obtained in a similar manner.

FIG. 8B is a diagram showing the left side boundary, the right side boundary, and the upper side boundary of the capable irradiation range of supplementary low beam ALB1. A range d5 is an overlapping range of range d3 defined by left side boundary 50 and right side boundary 51 (refer to FIG. 7C), and range d4 defined by upper side boundary 52. By using this range d5 as the capable irradiation range, it is possible to obtain a capable irradiation range assuming a preceding vehicle on the left lane side of the own vehicle's traffic lane, a preceding vehicle on the own vehicle's traffic lane, and an oncoming vehicle on the right lane side of the own vehicle. Here, as described above, the lower end of range d5 (i.e., lower side boundary 53) can be appropriately set at a position that is visible from the driver of the own vehicle.

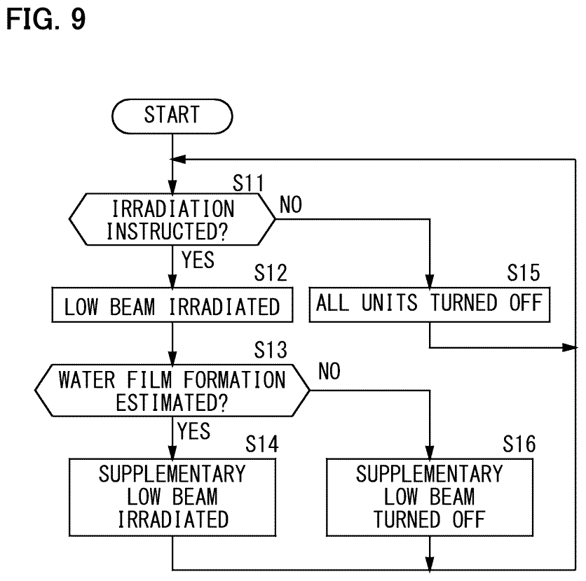

FIG. 9 is a flowchart showing the operating procedure of the vehicle headlight system 1 according to the first embodiment. In the first embodiment, a case will be described in which a supplementary low beam with a preset fixed irradiation range is used. Here, note that the order of each process shown here can be changed as long as no contradictions or inconsistencies occur in the results of the information processing, and other processes not explicitly disclosed here can also be added.

When the driver operates lamp switch 14 of the own vehicle to instruct headlight irradiation (step S11; YES), irradiation state setting unit 20 of controller 10 supplies a control signal to low beam units 31L, 31R of each headlight 11L, 11R to irradiate low beam. As a result, low beam is irradiated in front of the own vehicle (step S12). Here, an appropriate control signal is also supplied from irradiation state setting unit 20 to high beam units 33L, 33R.

Further, when road surface condition estimation unit 21 estimates road surface condition based on the detection results of rainfall sensor 12 and road surface sensor 13, and it is estimated that there is at least rainfall around the vehicle or wetness on the road surface on which the own vehicle is traveling, and therefore it is estimated that a water film is formed on the road surface (step S13; YES), irradiation state setting unit 20 supplies a control signal to supplementary low beam units 32L, 32R of each headlamp 11L, 11R to irradiate supplementary low beam. As a result, supplementary low beam is irradiated in front of the own vehicle (step S14). Here, a fixed irradiation range, which is predetermined within the capable irradiation range of the supplemental low beam is irradiated within the capable irradiation range (refer to FIG. 5A and FIG. 5B as an example). Then, the process returns to step S11.

On the other hand, in step S11 described above, when the driver operates lamp switch 14 of the own vehicle to instruct the headlights to stop irradiation (step S11; NO), irradiation state setting unit 20 of controller 10 supplies a control signal to turn off all units such as low beam units 31L, 31R of each headlight 11L, 11R. As a result, all units of each headlight 11L, 11R are turned off (step S15). Then, the process returns to step S11.

Further, in the above-described step S13, when it is estimated that there is no rainfall around the vehicle, or that the road surface on which the own vehicle is traveling is not wet, and therefore it is estimated that no water film has formed on the road surface (step S13; NO), irradiation state setting unit 20 supplies a control signal to supplementary low beam units 32L, 32R of each headlamp 11L, 11R to turn off the supplementary low beam. As a result, the supplementary low beam in front of the own vehicle is turned off (step S16). Here, note that the supplementary low beam may be completely turned off or may be controlled to reduce the illuminance to an extremely low state (the same applies hereinafter). Then, the process returns to step S11.

According to the first embodiment described above, a technology is provided to simultaneously ensure brightness on the near side in front of the own vehicle while preventing glare to other vehicles during rainy conditions, etc.

### Second Embodiment

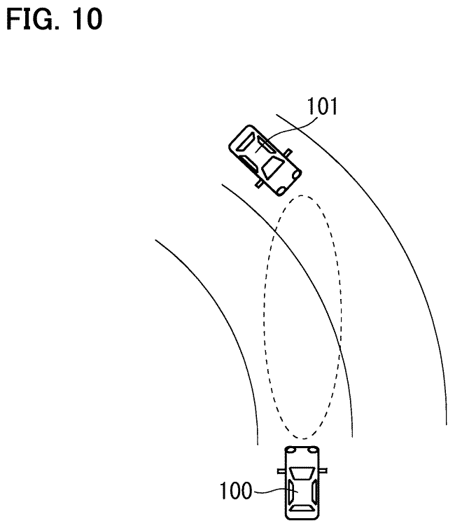

In the vehicle headlight system according to the first embodiment described above, it is also preferable to control the system so that supplementary low beam is not emitted when own vehicle 100 is traveling on a left curve road and an oncoming vehicle 101 is present, as shown in the schematic diagram of FIG. 10. In the following, a vehicle headlight system that performs such control will be described in detail. Here, note that descriptions of matters common to the first embodiment will be omitted where appropriate.

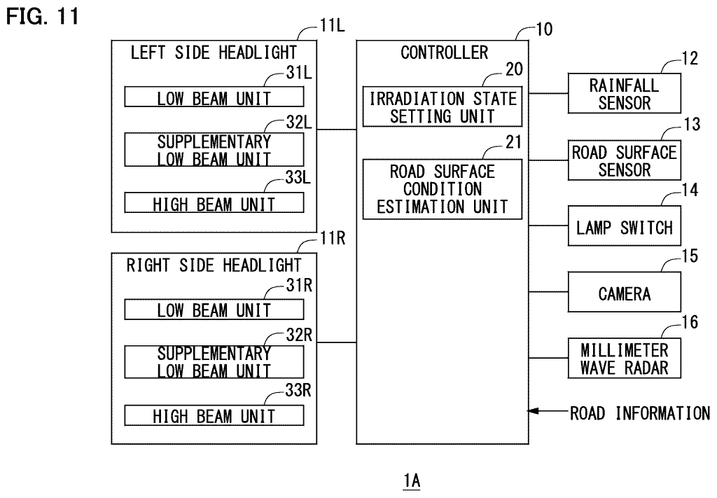

FIG. 11 is a block diagram showing the configuration of a vehicle headlight system according to the second embodiment. The basic configuration of the illustrated vehicle headlight system 1A is the same as that of the vehicle headlight system 1 of the first embodiment, but differs in that it is equipped with a camera 15 and a millimeter wave radar 16, each connected to controller 10, and is configured to be able to obtain road information from a navigation system (not shown) or the like. In the following, the main differences will be described. Here, in the second embodiment, rainfall sensor 12 and/or road surface sensor 13 correspond to a “first sensor”.

Camera 15 detects an oncoming vehicle, a preceding vehicle, etc. based on images obtained by photographing the space in front of the own vehicle. Millimeter wave radar 16 detects objects such as the oncoming vehicle and the preceding vehicle that are in front of the own vehicle by emitting radio waves (e.g. microwaves) into the space in front of the own vehicle and detecting the reflected waves. Here, in the second embodiment, camera 15 and/or millimeter wave radar 16 correspond to a “second sensor”.

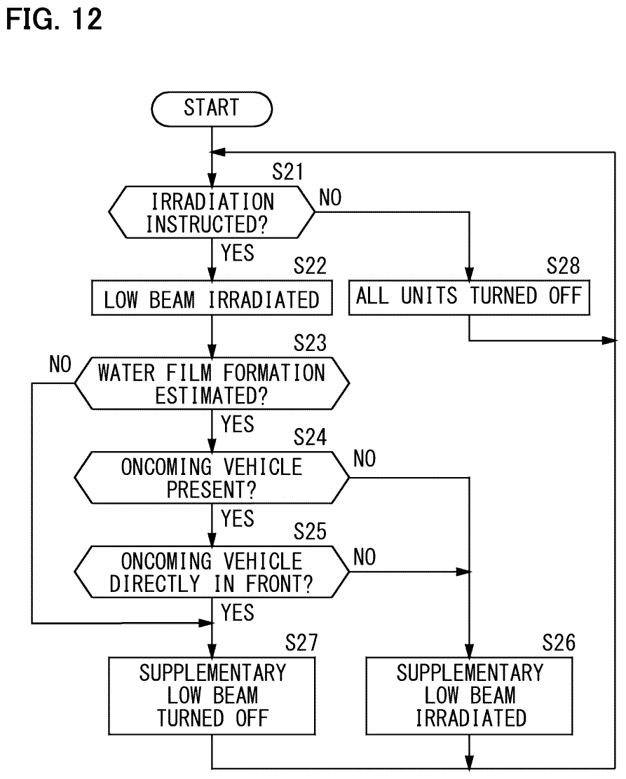

FIG. 12 is a flowchart showing the operating procedure of vehicle headlight system 1A according to the second embodiment. Also in the second embodiment, a case will be described in which a supplementary low beam with a preset fixed irradiation range is used. Here, note that the order of the processes shown here can be changed as long as no contradictions or inconsistencies occur in the results of the information processing, and other processes not explicitly disclosed here can also be added.

When the driver operates lamp switch 14 of the own vehicle to instruct headlight irradiation (step S21; YES), irradiation state setting unit 20 of controller 10 supplies a control signal to low beam units 31L, 31R of each headlight 11L, 11R to irradiate low beam. This causes low beam to be irradiated in front of the own vehicle (step S22). Here, irradiation state setting unit 20 also supplies an appropriate control signal to high beam units 33L, 33R.

Further, as a result of the road surface condition estimated by road surface condition estimation unit 21, when there is rainfall in the vicinity of the own vehicle, or when the road surface on which the own vehicle is traveling is wet, and therefore it is estimated that a water film is forming on the road surface (step S23; YES), and an oncoming vehicle is not present (step S24; NO), irradiation state setting unit 20 supplies a control signal to supplementary low beam units 32L, 32R of each headlamp 11L, 11R to cause them to irradiate supplementary low beam. As a result, the supplementary low beam is irradiated in front of the own vehicle (step S26). Here, a fixed irradiation range, which is predetermined within the capable irradiation range of the supplemental low beam is irradiated within the capable irradiation range (refer to FIG. 5A and FIG. 5B as an example). Then, the process returns to step S11.

Further, when an oncoming vehicle is present (step S24; YES) and when the oncoming vehicle position is not directly in front of the own vehicle (step S25; YES), irradiation state setting unit 20 also supplies a control signal to supplementary low beam units 32L, 32R of each headlamp 11L, 11R to cause them to emit supplementary low beam. As a result, the supplementary low beam is emitted in front of the own vehicle (step S26). Then, the process returns to step S21.

The determination of the presence or absence and position of the oncoming vehicle in steps S24 and S25 can be made based on either or both of the detection results of camera 15 and millimeter wave radar 16.

On the other hand, in the above-described step S23, when it is estimated that there is no rainfall around the own vehicle, or that the road surface on which the own vehicle is traveling is not wet, and therefore it is estimated that no water film is forming on the road surface (step S23; NO), irradiation state setting unit 20 supplies a control signal to supplementary low beam units 32L, 32R of each headlamp 11L, 11R to turn off the supplementary low beam. In other words, irradiation state setting unit 20 does not perform control to relatively increase the illuminance of the partial range. As a result, the supplementary low beam in front of the own vehicle is turned off (step S27). Then, the process returns to step S21.

Further, when an oncoming vehicle is present (step S24; YES) and the oncoming vehicle position is directly in front of the own vehicle (step S25: YES), irradiation state setting unit 20 supplies a control signal to supplementary low beam units 32L, 32R of each headlamp 11L, 11R to turn off the supplementary low beam. In other words, irradiation state setting unit 20 does not perform control to relatively increase the illuminance of the partial range. As a result, the supplementary low beam in front of the own vehicle is turned off (step S27). Then, the process returns to step S21.

On the other hand, when an instruction to stop headlamp irradiation is given in step S21 (step S21; NO), irradiation state setting unit 20 of controller 10 supplies a control signal to turn off all units such as low beam units 31L, 31R of each headlamp 11L, 11R. As a result, all units of headlamps 11L, 11R are turned off (step S28). Then, the process returns to step S21.

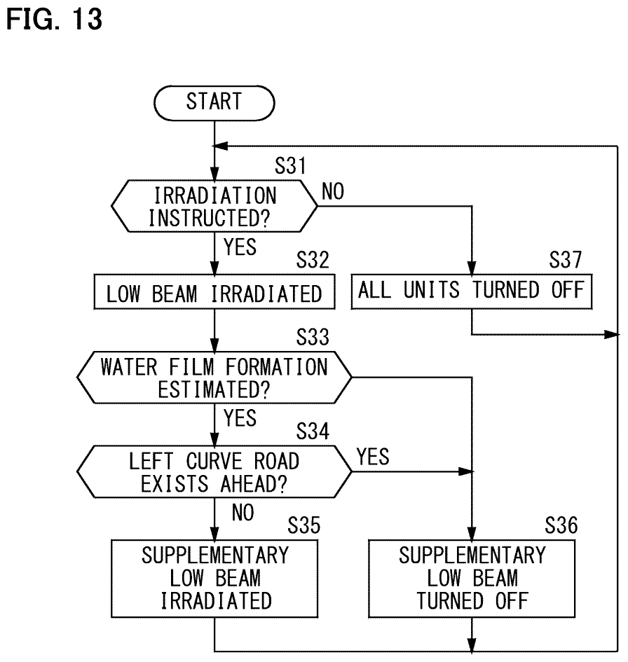

FIG. 13 is a flowchart showing another aspect of the operating procedure of the vehicle headlight system 1A according to the second embodiment. In this second embodiment as well, a case will be described in which an supplementary low beam with a preset fixed irradiation range is used. Here, note that the order of each process shown here can be changed as long as no contradictions or inconsistencies occur in the results of the information processing, and other processes not explicitly disclosed here can also be added.

When the driver operates lamp switch 14 of the own vehicle to instruct headlight irradiation (step S31; YES), irradiation state setting unit 20 of controller 10 supplies a control signal to low beam units 31L, 31R of each headlight 11L, 11R to irradiate low beam. As a result, low beam is irradiated in front of the own vehicle (step S32). Here, an appropriate control signal is also supplied from irradiation state setting unit 20 to high beam units 33L, 33R.

Further, as a result of the road surface condition estimated by road surface condition estimation unit 21, when there is rainfall in the vicinity of the own vehicle, or when the road surface on which the own vehicle is traveling is wet, and thus it is estimated that a water film is forming on the road surface (step S33; YES), and a left curve ahead of the own vehicle does not exist (step S34; NO), irradiation state setting unit 20 supplies a control signal to supplementary low beam units 32L, 32R of each headlamp 11L, 11R to cause them to irradiate supplementary low beam. As a result, the supplementary low beam is emitted in front of the own vehicle (step S35).

Here, a fixed irradiation range, which is predetermined within the capable irradiation range of the supplemental low beam is irradiated within the capable irradiation range (refer to FIG. 5A and FIG. 5B as an example). Whether or not there is a left curve in step S34 can be determined based on road information (road data) obtained from a navigation system (not shown) or the like. Further, the presence or absence of a left curve may also be detected by camera 15. After execution of step S35, the process returns to step S31.

Further, in the above-described step S33, when it is estimated that there is no rainfall around the vehicle, or that the road surface on which the own vehicle is traveling is not wet, and therefore it is estimated that no water film is forming on the road surface (step S33; NO), irradiation state setting unit 20 supplies a control signal to supplementary low beam units 32L, 32R of each headlamp 11L, 11R to turn off the supplementary low beam. In other words, irradiation state setting unit 20 does not perform control to relatively increase the illuminance of a partial range. As a result, the supplementary low beam in front of the own vehicle is turned off (step S36). Then, the process returns to step S31.

Further, when a left curve road ahead of the own vehicle does exist (step S34; YES), irradiation state setting unit 20 supplies a control signal to supplementary low beam units 32L, 32R of each headlamp 11L, 11R to turn off the supplementary low beam. In other words, irradiation state setting unit 20 does not perform control to relatively increase the illuminance of the partial range. As a result, the supplementary low beam in front of the vehicle is turned off (step S36). Then, the process returns to step S31.

On the other hand, when an instruction to stop headlamp irradiation is given in step S31 (step S31; NO), irradiation state setting unit 20 of controller 10 supplies a control signal to turn off all units, such as low beam units 31L, 31R of each headlamp 11L, 11R. As a result, all units of headlamps 11L, 11R are turned off (step S37). Then, the process returns to step S31.

According to the second embodiment described above as well, a technology is provided to simultaneously ensure brightness on the near side in front of the own vehicle while preventing glare to other vehicles during rainy conditions, etc. Further, when there is a left curve road ahead of the own vehicle and the relative position of the oncoming vehicle is in front of the own vehicle, the supplementary low beam is turned off, thereby glare to the oncoming vehicle can be prevented.

Here, as a modified example of the second embodiment, the supplementary low beam may be controlled to be turned off when a preceding vehicle is present within a predetermined distance in front of the own vehicle.

### Third Embodiment

In the first and second embodiments described above, it has been assumed that the supplementary low beam is used with a fixed irradiation range set in advance within the capable irradiation range of the supplementary low beam. However, it is also preferable to dynamically estimate the eye position of the driver of an oncoming vehicle and variably set the irradiation range of the supplementary low beam based on the estimation result. In the following, a vehicle headlight system which performs such control will be described in detail. Here, note that descriptions of matters common to the first and second embodiments will be omitted where appropriate.

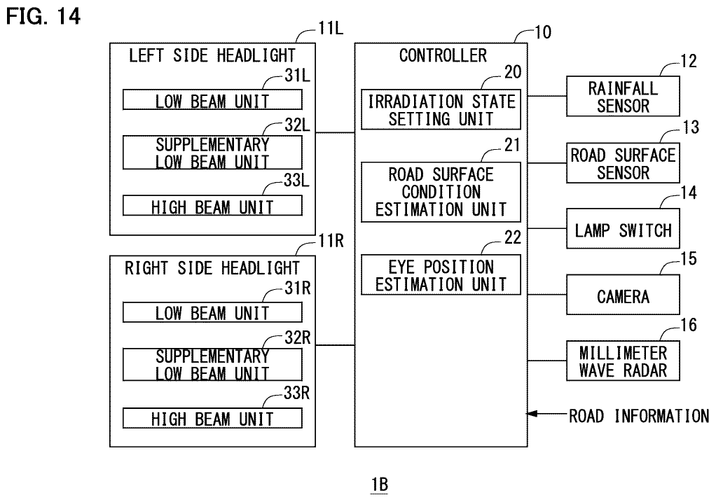

FIG. 14 is a block diagram showing the configuration of a vehicle headlight system according to the third embodiment. The basic configuration of the illustrated vehicle headlight system 1B is the same as that of the vehicle headlight system 1A of the second embodiment, with the differences being that controller 10 has, as its functional block, an eye position estimation unit 22 which estimates eye position of the driver of an oncoming vehicle (hereinafter simply referred to as “eye position”) in real time, and that the irradiation range of the supplementary low beam is variably set by irradiation state setting unit 20 based on the estimation result by this eye position estimation unit 22. In the following, the main differences will be explained.

Eye position estimation unit 22 estimates the eye position based on the relative distance (distance from the own vehicle to the oncoming vehicle) and vehicle type (e.g., sedan, SUV, truck, etc.) of the oncoming vehicle detected by camera 15 and/or millimeter wave radar 16. Eye position estimation is performed at regular intervals (e.g., every few tens of milliseconds). The eye position can be estimated by storing a data table in a memory (not shown) that indicates the vertical position (i.e., height) and horizontal position based on the own vehicle's position for each vehicle type and relative distance, and referring to the data table. Such data table can be created using publicly available information. Further, the relative distance from the own vehicle to the oncoming vehicle is obtained by camera 15 or millimeter wave radar 16.

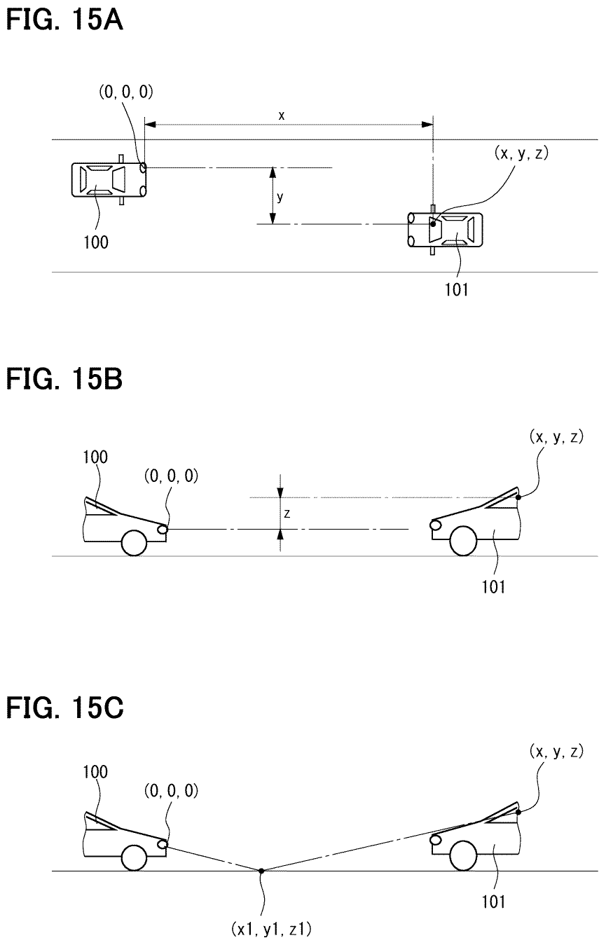

FIG. 15A is an overhead view showing the relative positional relationship between the own vehicle and an oncoming vehicle. FIG. 15B and FIG. 15C are side views showing the relative positional relationship between the own vehicle and an oncoming vehicle. As shown in each figure, the installation position of left side headlight 11L of own vehicle 100, more specifically, the light emission center of the supplementary low beam, is set as the origin (0, 0, 0), and the eye position of the driver of an oncoming vehicle 101 is set as (x, y, z). The x-axis corresponds to the front-rear direction of own vehicle 100, the y-axis corresponds to the left-right direction of own vehicle 100, and the z-axis corresponds to the height direction (vertical direction) of own vehicle 100.

When the eye position (x, y, z) of the oncoming vehicle 101 based on the origin (0, 0, 0) which is the light emission center of the supplementary low beam, is expressed using left-right direction angle θ1 [deg] and up-down direction angle θ2 [deg], these can be expressed by the following equations, respectively.

$$\begin{matrix}LR ( deg ) = θ1 & tan θ 1 = \frac{y}{\sqrt{{x}^{2} + {z}^{2}}} \\ UD ( deg ) = θ2 & tan θ2 = \frac{z}{\sqrt{{x}^{2} + {y}^{2}}}\end{matrix} \qquad ( Equation 1 )$$

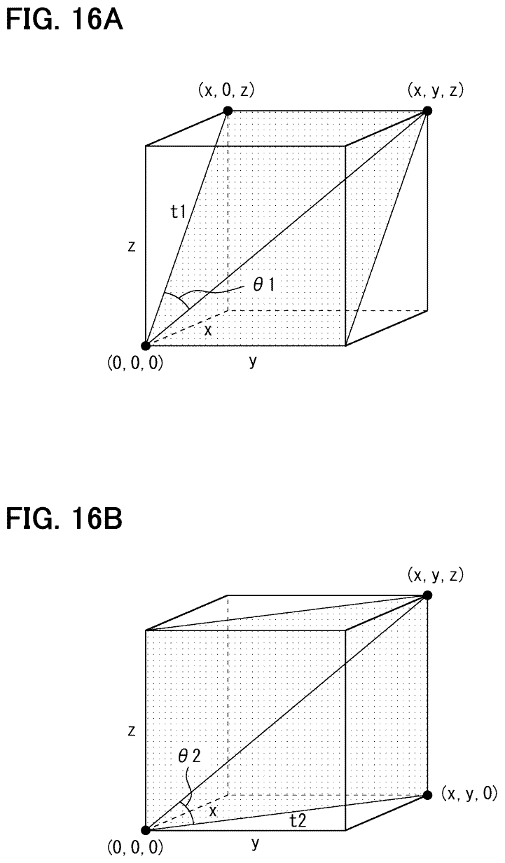

FIG. 16A is a diagram showing the definition of the left-right direction angle θ1. A plane (t1-y plane) is created by a straight line t1 and the y-axis, where straight line t1 connects the projected eye position (x, 0, z) obtained by projecting eye position (x, y, z) onto the xz plane and the origin (0, 0, 0). On this t1-y plane, the angle between the straight line connecting the origin (0, 0, 0) and eye position (x, y, z) and straight line t1 is defined as θ1.

FIG. 16B is a diagram showing the definition of the up-down direction angle θ2. A plane (t2-z plane) is created by a straight line t2 and the z axis, where straight line t2 connects the projected eye position (x, y, 0) obtained by projecting eye position (x, y, z) onto the xy plane and the origin (0, 0, 0). On this t2-z plane, the angle between the straight line connecting the origin (0, 0, 0) and eye position (x, y, z), and straight line t2 is defined as θ2.

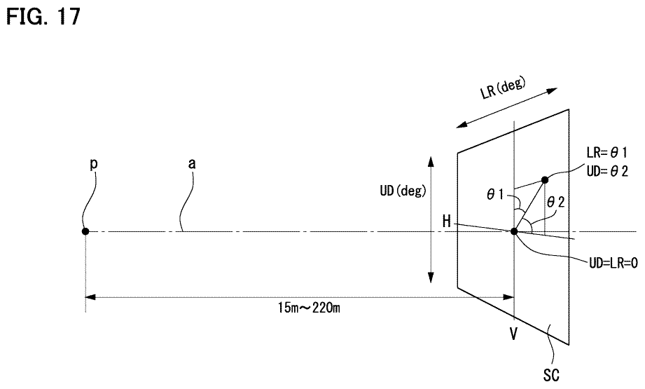

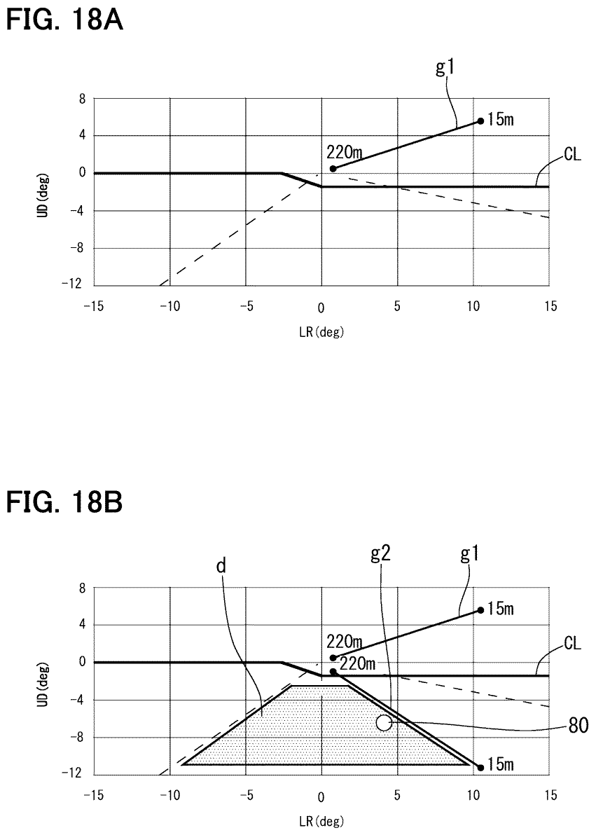

FIG. 17 is a diagram for explaining the corresponding relationship on the screen between left-right direction angle θ1 and up-down direction angle θ2. The distance between the light emission center “p” of the supplementary low beam and a screen SC is 15 m to 220 m, for example. Further, at the intersection point between the optical axis “a” of the supplementary low beam and screen SC, both the horizontal direction H and the vertical direction V are defined as 0. In other words, at the intersection point, both up-down direction angle θ1 and left-right direction angle θ2 are 0 (UD=LR=0). The point on the screen specified by left-right direction angle θ1 and up-down direction angle θ2 corresponds to eye position (x, y, z). When this change in eye position is shown on the screen, it becomes like a line segment g1 shown in FIG. 18A. By using up-down direction angle θ1 and left-right direction angle θ2, which can be calculated in real time in this way, it is possible to control the light directed at the driver of an oncoming vehicle while taking into account the depth.

Next, as shown in FIG. 15C, assuming that the supplementary low beam is mirror-reflected (regularly reflected) at the road surface, the road surface coordinates of the reflection position of the reflected light that enters the eye position of the oncoming vehicle 101 is defined as (x1, y1, z1).

When the position of the road surface coordinates (x1, y1, z1) based on the origin (0, 0, 0) which is the light emission center of the supplementary low beam, is expressed using left-right direction angle θ3 [deg] and a up-down direction angle θ4 [deg], these can be expressed by the following equations, respectively.

$$\begin{matrix}LR ( deg ) = θ 3 = θ 1 \\ UD ( deg ) = θ4 \\ tan θ4 = \frac{z 1}{\sqrt{{x}^{2} + {y}^{2}} * \frac{z 1}{z 1 + z 1 + z}}\end{matrix} \qquad ( Equation 2 )$$

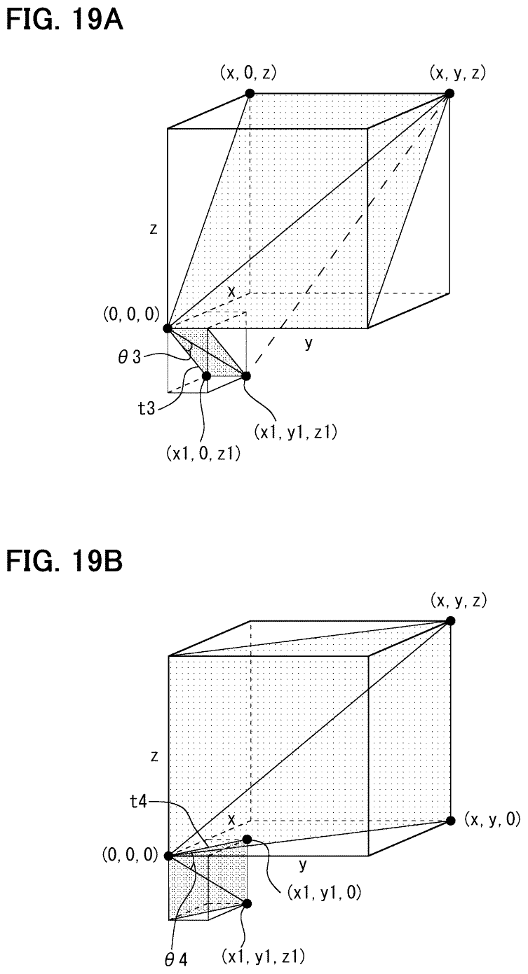

FIG. 19A is a diagram showing the definition of the left-right direction angle θ3. A plane (t3-y plane) is created by a straight line t3 and the y-axis, where straight line t3 connects the projected road surface coordinates (x1, 0, z1) obtained by projecting the road surface coordinates (x1, y1, z1) onto the xz plane and the origin (0, 0, 0). On this t3-y plane, the angle between the straight line connecting the origin (0, 0, 0) and the road surface coordinates (x1, y1, z1), and straight line t3 is defined as θ3.

FIG. 19B is a diagram showing the definition of the up-down direction angle θ4. A plane (t4-y plane) is created by a straight line t4 and the z axis, where straight line t4 connects the projected road surface coordinates (x1, y1, z1) obtained by projecting the road surface coordinates (x1, y1, 0) onto the xy plane, and the origin (0, 0, 0). On this t4-z plane, the angle between the straight line connecting the origin (0, 0, 0) and the road surface coordinates (x1, y1, z1), and straight line t4 is defined as θ4.

When the transition of eye position determined by left-right direction angle θ3 and up-down direction angle θ4 is shown on a screen in this way, it becomes like a line segment “g2” shown in FIG. 18B. By using up-down direction angle θ3 and left-right direction angle θ4 which can be calculated in this way, it is possible to dynamically prevent glare caused by the reflected light directed to the driver of an oncoming vehicle. Specifically, within the irradiation range of the supplementary low beam, the road surface coordinates determined based on up-down direction angle θ3 and left-right direction angle θ4 are calculated in real time, and illuminance of a light shielding range 80 (refer to FIG. 18B) which includes the position of the road surface coordinates is controlled so as not to increase relatively. As a result, this makes it possible to ensure a larger irradiation range “d” of the supplementary low beam within the capable irradiation range while preventing glare to the oncoming vehicle.

Here, although detailed explanations will be omitted to avoid duplication, a light shielding range in which illuminance should be relatively reduced in relation to right side headlight 11R can be determined using logic similar to that in relation to left side headlight 11L described above.

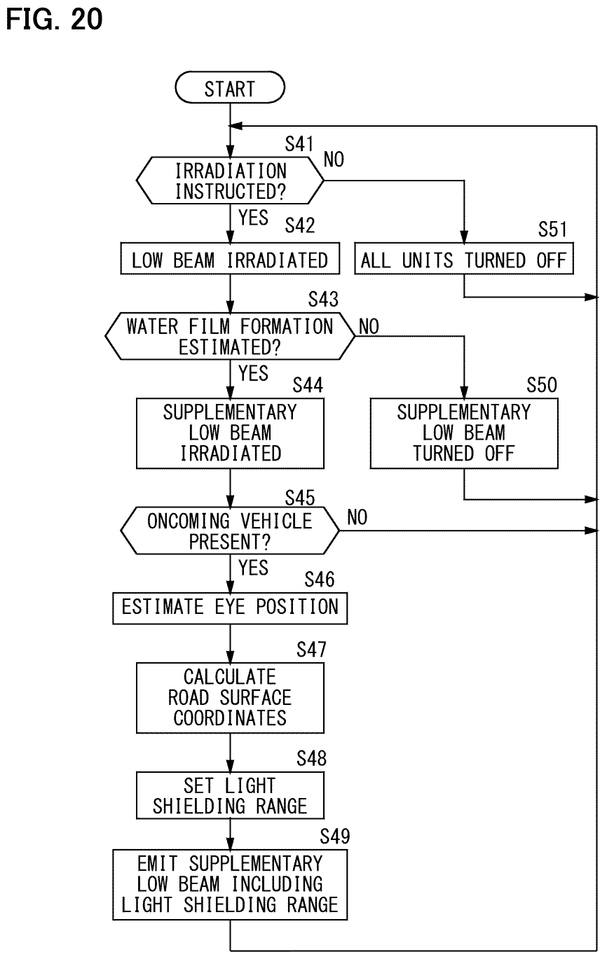

FIG. 20 is a flowchart showing the operation procedure of a vehicle headlight system 1B according to the third embodiment. In the third embodiment, a supplementary low beam with a preset fixed irradiation range “d” (refer to FIG. 18B) is used, and a light shielding range 80 (refer to FIG. 18B) is dynamically set within the irradiation range of the supplementary low beam so that the illuminance of the light shielding range 80 is not relatively increased. Here, note that the order of the processes shown here can be changed as long as no contradictions or inconsistencies occur in the results of the information processing, and other processes not explicitly disclosed here can also be added.

When the driver operates lamp switch 14 of the own vehicle to instruct headlight irradiation (step S41; YES), irradiation state setting unit 20 of controller 10 supplies a control signal to low beam units 31L, 31R of each headlight 11L, 11R to irradiate low beam. As a result, the low beam is irradiated in front of the own vehicle (step S42). Here, an appropriate control signal is also supplied from irradiation state setting unit 20 to high beam units 33L, 33R.

Further, as a result of the road surface condition estimated by road surface condition estimation unit 21, when there is rainfall in the vicinity of the own vehicle, or when the road surface on which the own vehicle is traveling is wet, and therefore it is estimated that a water film is forming on the road surface (step S43; YES), irradiation state setting unit 20 supplies a control signal to supplementary low beam units 32L, 32R of each headlamp 11L, 11R to cause them to irradiate supplementary low beam. As a result, the supplementary low beam is irradiated in front of the own vehicle (step S44). Here, a fixed irradiation range “d” (refer to FIG. 18B as an example), which is predetermined within the capable irradiation range of the supplemental low beam is irradiated within the capable irradiation range.

Further, when the presence of an oncoming vehicle is detected by either or both of camera 15 and millimeter wave radar 16 (step S45; YES), eye position estimation unit 22 estimates eye position of the driver of the oncoming vehicle (step S46). On the other hand, when the presence of an oncoming vehicle is not detected (step S45; NO), the process returns to step S41.

Based on the eye position (x, y, z) estimated by eye position estimation unit 22, light distribution state setting unit 20 calculates the road surface coordinates (x1, y1, z1) (step S47), and sets a light shielding range 80 based on the road surface coordinates (step S48). Light shielding range 80 may be set, for example, as a circle of a predetermined radius centered on the road surface coordinates, or as a square or rectangle with the road surface coordinates as its center of gravity, or it may be set to any other shape. The size (area) of light shielding range 80 may be appropriately determined based on experiments, simulations (theoretical calculations), etc.

Irradiation state setting unit 20 supplies a control signal to supplementary low beam units 32L, 32R of headlights 11L, 11R to emit a supplementary low beam including light shielding range 80. As a result, the supplementary low beam including light shielding range 80 (refer to FIG. 18B as an example) is emitted in front of the own vehicle (step S49). Then, the process returns to step S41.

The processes from step S41 onwards are repeated at a predetermined interval (e.g., every few tens of milliseconds), so that light shielding range 80 is dynamically reconfigured in accordance with changes over time in the position of the oncoming vehicle.

On the other hand, when an instruction to stop headlamp irradiation is given in step S41 (step S41; NO), irradiation state setting unit 20 of controller 10 supplies a control signal to turn off all units such as low beam units 31L, 31R of each headlamp 11L, 11R. As a result, all units of headlamps 11L, 11R are turned off (step S50). Then, the process returns to step S41.

Further, when there is no rainfall in the vicinity of the own vehicle, or when the road surface on which the own vehicle is traveling is not wet, and therefore it is estimated that no water film is forming on the road surface (step S43; NO), irradiation state setting unit 20 supplies a control signal to supplementary low beam units 32L, 32R of each headlamp 11L, 11R to turn off the supplementary low beam. In other words, irradiation state setting unit 20 does not perform control to relatively increase the illuminance of a partial range. As a result, the supplementary low beam in front of the own vehicle is turned off (step S51). Then, the process returns to step S41.

In the third embodiment as described above as well, a technology is provided to simultaneously ensure brightness on the near side in front of the own vehicle while preventing glare to other vehicles during rainy conditions, etc. Further, in accordance with changes over time in the position of the oncoming vehicle, since light shielding range 80 is set in real time within the irradiation range “d” of the supplementary low beam, it is possible to ensure a wider irradiation range “d” of the supplementary low beam while preventing glare to the oncoming vehicle.

### Modified Example

Here, note that the present disclosure is not limited to the contents of the above-described embodiments, and various modifications can be made within the scope of the gist of the present disclosure. For example, in the above-described embodiments, it is assumed that the own vehicle is required by law to drive on the left side of the road and the oncoming lane is located on the right side of the own vehicle, but the contents of the present disclosure can be applied in the same manner even when the vehicle drives on the right side of the road and the oncoming lane is located on the left side of the own vehicle. In this case, it is sufficient to simply switch the left and right positional relationships in the above-described embodiments and the positional relationship between the preceding vehicle and the oncoming vehicle.

### Description of Symbols

1: Vehicle headlight system
10: Controller
11L: Left side headlight
11R: Right side headlight
12: Rainfall sensor
13: Road surface sensor
14: Lamp switch
20: Irradiation state setting unit
21: Road surface condition estimation unit
31L, 31R: Low beam unit
32L, 32R: Supplementary low beam unit
33L, 33R: High beam unit

What is claimed is:

1. A vehicle headlight system comprising:
a pair of headlights arranged in front of an own vehicle;
a sensor configured to detect at least rainfall or wet road condition around the own vehicle; and
a controller connected to the pair of headlights and the sensor and configured to control the operation of the pair of headlights,
wherein the pair of headlights are configured to be able to irradiate low beam at least in front of the own vehicle and to change the illuminance of a partial range within an irradiation range of the low beam, and
wherein, when formation of water film is estimated based on the detection results of the sensor, the controller controls the irradiation state of the pair of headlights so as to relatively increase the illuminance of the partial range.

2. The vehicle headlight system according to claim 1,
wherein the partial range is set to be included within a capable irradiation range defined between (i) a right side boundary that is set based on a first road surface coordinate which is a reflection position of a light from the pair of headlights on the road surface when the light is regularly reflected from the road surface and incident on a first position of a first forward vehicle assumed to be present at the front right side of the own vehicle, and (ii) a left side boundary that is set based on a second road surface coordinate which is a reflection position of the light from the pair of headlights on the road surface when the light is regularly reflected from the road surface and incident on a second position of a second forward vehicle assumed to be present oat the front left side of the own vehicle.

3. The vehicle headlight system according to claim 1,
wherein the partial range is set as a fixed range.

4. The vehicle headlight system according to claim 1,
wherein the partial range is set to a range smaller than the capable irradiation range.

5. The vehicle headlight system according to claim 2,
wherein the right side boundary is determined based on a first line segment as a collection of the first road surface coordinates obtained by setting a relative distance between the first forward vehicle and the own vehicle within a predetermined distance, and
wherein the left side boundary is determined based on a second line segment as a collection of the second road surface coordinates obtained by setting a relative distance between the second forward vehicle and the own vehicle within a predetermined distance.

6. The vehicle headlight system according to claim 2,
wherein the first forward vehicle is an oncoming vehicle and the second forward vehicle is a preceding vehicle.

7. The vehicle headlight system according to claim 6,
wherein the first position is a position estimated as an eye position of a driver of the oncoming vehicle, and
wherein the second position is a position estimated as a mirror position of the preceding vehicle.

8. The vehicle headlight system according to claim 6,
wherein the controller does not perform control to relatively increase the illuminance of the partial range when the own vehicle is traveling on a left hand curve, even when the formation of the water film is estimated.

9. The vehicle headlight system according to claim 1,
wherein, even when the formation of the water film is estimated, when an oncoming vehicle is present directly in front of the own vehicle, the controller does not perform control to relatively increase the illuminance of the partial range.

10. The vehicle headlight system according to claim 1,
wherein the pair of headlights is configured to include a first unit capable of irradiating the low beam and a second unit capable of irradiating the partial range with light.

11. The vehicle headlight system according to claim 1,
wherein the pair of headlights is configured to include a third unit capable of increasing or decreasing the illuminance of the partial range while capable of irradiating the low beam.

12. A vehicle headlight system comprising:
a pair of headlights arranged in front of an own vehicle;
a first sensor configured to detect at least rainfall or wet road condition around the own vehicle;
a second sensor configured to detect the position, the vehicle type, and the relative distance between the own vehicle and an other vehicle present at least on the front right side or the front left side of the own vehicle;
a controller connected to the pair of headlights, the first sensor, and the second sensor, and configured to control the operation of the pair of headlights,
wherein the pair of headlights are configured to be able to irradiate low beam at least in front of the own vehicle and to change the illuminance of a range within an irradiation range of the low beam,
wherein, based on the detection results of the first sensor, when formation of a water film is estimated, the controller controls the irradiation state of the pair of headlights so as to relatively increase the illuminance of the partial range, and
wherein, based on the position, vehicle type, and relative distance of the other vehicle detected by the second sensor, the controller estimates eye position of a driver of the other vehicle, and according to the estimated eye position, the controller calculates in real time a first road surface coordinate which is the reflection position of the light on the road surface when the light from the pair of headlights is regularly reflected on the road surface and incident on a first position of the other vehicle, sets a light shielding range based on the first road surface coordinate calculated in real time, and controls the irradiation state of the pair of headlights so as not to relatively increase the illuminance within the light shielding range.
